(19) United States
(12) Patent Application Publication
(10) Pub. No.: US 2012/0190812 A1
(43) Pub. Date: Jul. 26, 2012

(54) PLANT-BASED POLYCARBONATE RESIN AND PRODUCTION METHOD THEREOF

(75) Inventors: Yoshiaki OKABE, Hitachi (JP); Hiroyuki KAGAWA, Hitachinaka (JP); Fusao HOJO, Tokai (JP)

(73) Assignee: Hitachi, Ltd.

(21) Appl. No.: 13/358,529

(22) Filed: Jan. 26, 2012

(30) Foreign Application Priority Data
Jan. 26, 2011 (JP) 2011-013919

(51) Int. Cl. C08H 7/00; C08G 64/02; C08B 15/00; C08B 37/00

(52) U.S. Cl. 527/300; 527/400; 528/271

(57) ABSTRACT

Provided is an environmentally friendly novel plant-based polycarbonate resin. Specifically, disclosed are: a plant-based polycarbonate resin which is a polymer derived from a plant-based material having a plurality of hydroxyl groups, in which molecules of the plant-based material are linked to each other through carbonate groups to form the polymer; and a production method of the polycarbonate resin.

### CLAIM OF PRIORITY

The present application claims priority from Japanese patent application serial no. 2011-013919 filed on Jan. 26, 2011, the content of which is hereby incorporated by reference into this application.

### FIELD OF THE INVENTION

The present invention relates to polycarbonate resins derived from plant-based materials. More specifically, the present invention relates to plant-based polycarbonate resins which include a plant-based material as a skeleton and excel in proccessability (formability), strength, and thermal stability; and production methods of the resins.

### BACKGROUND OF THE INVENTION

Mass usage of petroleum resources may cause global warming and resource depletion, and to avoid these, measures such as savings in resources and energy have been advanced. Among them, development of resins obtained from plant resource materials is considered as promising. As one of such resins, there are polycarbonate resins prepared from plant-based materials as raw materials. Polycarbonate resins are one of five major commodity engineering plastics and are resins each prepared by linking molecules of an aromatic or aliphatic dioxy compound through carbonate groups. Among them, those obtained from bisphenol-A (2,2-bis(4-hydrooxyphenyl)propane) have satisfactory performance typically in formability, thermal stability, and strength and are used in a wide range of areas.

Customarily known plant-based resins include polylactic acids and polybutylene succinates. These resins, however, are not sufficient in formability and/or strength. Independently, exemplary plant-based materials include lignin, lignophenol, tannin, xylitol, xylose, sorbitol, and cellulose. Of these, lignin is present in plant components in the next largest amount after cellulose and is a polyphenol structurally having a thermostable skeleton. Epoxy resin cured articles using lignin or lignin derivative lignophenol as an epoxy resin or a curing agent are known to show satisfactory thermal stability (Japanese Unexamined Patent Application Publication (JP-A) No. 2010-241855).

In contrast, bisphenol-A as a petroleum-based material is widely used as a raw material for epoxy resins and polycarbonate resins and is known as an inceptive chemical relating to issues of endocrine disruptors (environmental hormones) in Japan. Recent studies have reported that the endocrine disruptors, when present in such low concentrations as to be detected from the environment, do not adversely affect the human body, and thereafter, the endocrine disruptors crisis has been rapidly calmed down. However, new risks are found on bisphenol-A, and its adverse effects on aquatic organisms are nonnegligible. To avoid these, it is desirable to employ, if possible, plant-based polycarbonate resins instead of such petroleum-based resins. This is because the plant-based polycarbonate resins are carbon-neutral materials and are free from the above-mentioned problems.

One of customary techniques relating to plant-based polycarbonate resins is a technique disclosed in JP-A No. 2010-083905. This technique relates to a polycarbonate resin including a constitutional unit of terpenediol. In this technique, isosorbide as a raw material for terpenediol is obtained by hydrogenising a starch, and performing a dehydration reaction of the resulting compound. However, starches are foodstuffs, and it is not desirable to use these starches as raw materials for polycarbonate resins, because of expected food crisis in future. JP-A No. 2010-150424 discloses another customary technique. This technique relates to a blend of a petroleum-based polycarbonate resin with a plant-based polylactic acid resin. However, the polylactic acid used herein is obtained from corn or sweet potato as a raw material, and it is not desirable to use these corn and sweet potato as raw materials for polycarbonate resins.

Under these circumstances, the present inventors made investigations on a plant-based polycarbonate obtained from plant-based materials which are contained not in human foodstuffs but in plants in large amounts, and most of them are at present discarded without use. As a result of these investigations, the present invention has been made.

A plant-based polycarbonate resin according to the present invention is obtained by converting an inedible plant-based material (biomass) having hydroxyl groups, such as lignin or a lignin derivative, into a carbonate (carbonic acid ester). In general, the customary petroleum-based polycarbonate resins are obtained also by converting hydroxyl groups of bisphenol-A into carbonic esters. The resulting polycarbonate resins are linear thermoplastic resins because bisphenol-A is a compound having two hydroxyl groups. These resins therefore have both good formability and strength. In contrast, most of plant-based materials each have a plurality of hydroxyl groups. In this art, it has been a common sense that polycarbonate resins obtained by converting these plant-based materials into carbonates are insoluble and infusible resins. Under these circumstances, the present inventors made intensive investigations to provide a polycarbonate resin which has both good solubility and satisfactory strength and is obtained by using an inedible plant-based material. The present inventors focused attention on such low reactivity of hydroxyl groups of plant-based materials. JP-A No. 2009-084320 describes that only 25% of a multiplicity of hydroxyl groups contained in lignin, a plant-based material, are reacted.

Though being not described in JP-A No. 2009-084320, the present inventors considered that most of the plurality of hydroxyl groups of lignin remain unreacted due typically to steric hindrance of adjacent methoxy groups and of lignin itself, and this lowers the reaction rate of hydroxyl groups. Based on this consideration, they thought that the formability of a polycarbonate resin is significantly improved by synthetically preparing the same while suppressing the carbonic-esterification of lignin. They performed such synthesis, and, as a result, they have found that the synthesized plant-based polycarbonate resin has many advantages typically in solvent solubility, formability, and strength. The present invention has been made based on these findings.

An object of the present invention is to provide a novel polycarbonate resin usable as a commodity resin, to provide a polycarbonate resin excellent in formability, and to provide a polycarbonate resin excellent in thermal stability and mechanical strength, by choosing a suitable plant-based material. Another object of the present invention is to provide a polycarbonate resin using, of such plant-based materials, lignin or a lignin derivative as a raw material, which polycarbonate resin has superior performance typically in formability and/or strength even though the raw material plant-based material is a multifunctional substance.

### SUMMARY OF THE INVENTION

Typical embodiments of the present invention will be sequentially illustrated below.

(1) Specifically, the present invention provides, in an aspect, a polycarbonate resin including a polymer derived from a plant-based material having a plurality of hydroxyl groups, molecules of the plant-based material being linked to each other through carbonate groups to form the polymer.

As the plant-based material, lignin and derivatives thereof, and tannin are suitable for the preparation of polycarbonate resins excellent in thermal stability and mechanical properties, because these are phenolic compounds. In contrast, alicyclic or linear chain materials, such as xylose, xylitol, sorbitol, and cellulose, are usable as novel materials for polycarbonate resins which excel in solvent solubility, though the resins have not-so-high thermal stability and mechanical strength as compared to the polycarbonate resins using lignin or a derivative thereof as a raw material. Vegetable oils are also usable as the plant-based material. In this connection, regular vegetable oils are utilized in foodstuffs and pharmaceuticals and may not be so preferred materials in consideration of food resource issues. However, some types of vegetable oils separated from algae and vegetable oils which are considered inedible, such as copaiba oil and petroleum nut oil, are materials having use values, as long as effective utilization of resources is possible. It should be noted, however, that the present invention does not wholly deny the utilization of vegetable oils for use in foodstuffs or pharmaceuticals as the plant-based materials herein.

The polycarbonate resin according to the present invention is applicable to various applications, because the resin is soluble in general organic solvents such as 4-hydroxy-4-methyl-2-pentanone, acetone, toluene, xylene, benzene, chloroform, tetrahydronaphthalene, tetrahydrofuran, butyl acetate, dimethylformamide, 1-methylpyrrolidone, and diethyl ether. In addition, the polycarbonate resin according to the present invention can be easily kneaded typically with another resin component and can be easily formed into a sheet.

(2) In a preferred embodiment of the polycarbonate resin according to (1), the plant-based material is at least one selected from the group consisting of lignin, lignophenol, tannin, xylitol, xylose, sorbitol, cellulose, and vegetable oils.

Lignin, lignin derivatives (e.g., lignophenol),and tannin each have aromatic rings and can give polycarbonate resins excellent in thermal stability and mechanical strength.

(3) In another embodiment of the polycarbonate resin according to (1) or (2), the plant-based material to be used preferably has a weight-average molecular weight (hereinafter briefly referred to as MW) of from 300 to 8000.

(4) In yet another embodiment, the polycarbonate resin according to (1) or (2) preferably has a weight—average molecular weight of from 2000 to 60000.

(5) The present invention provides, in another aspect, a polycarbonate resin including a copolymer of a plant-based material having a plurality of hydroxyl groups and a bifunctional hydroxyl-containing petroleum-based material, hydroxyl groups of the plant-based material and hydroxyl groups of the petroleum-based material being converted into carbonate groups to be combined to each other and to form the copolymer.

(6) The present invention also provides, in still another aspect, a polycarbonate resin blend as a kneading of the plant-based polycarbonate resins according to (1) with a petroleum-based polycarbonate resin.

(7) In another embodiment, the polycarbonate resin according to (1), (5) or (6) derived from a plant-based material has a melt flow rate of 35 g or more and a flexural strength of 60 MPa or more.

(8) The present invention provides, in another aspect, a product including an electric appliance such as an electric vacuum cleaner, a television set, a refrigerator, or a washing machine, or an automobile part, which product includes a molded article prepared from the polycarbonate resin according to (1), (5) or (6) including a plant-based material.

(9) In an embodiment, the polycarbonate resin according to (1) derived from the plant-based material may further has at least one type of substituent introduced into part or all of hydroxyl groups of the polycarbonate resin.

(10) In yet another aspect, the present invention provides a method for producing a polycarbonate resin. This method includes the steps of converting hydroxyl groups of a plant-based material into carbonate groups; and polymerizing the plant-based material.

(11) In an embodiment of the method according to (10), the step of converting into carbonate groups may be performed by reacting the plant-based material with phosgene or by reacting the plant-based material through melt polymerization.

The present invention provides environmentally friendly novel thermoplastic polycarbonate resins each including a plant-based material as a skeleton. In particular, the use of lignin or a lignin derivative as the plant-based material gives novel polycarbonate resins which excel in solubility in organic solvents, thermal stability, and mechanical properties.

### BRIEF DESCRIPTION OF THE DRAWINGS

FIG. 1 is a view illustrating a reaction mechanism of a lignin-based polycarbonate resin.

### DETAILED DESCRIPTION OF THE PREFERRED EMBODIMENTS

In the present invention, plant-based polycarbonate resins and copolymerized polycarbonate resins obtained by carbonic-esterification of hydroxyl groups of a plant-based material and a conventional petroleum-based material, as described in (1) to (5) above, may be prepared by synthesis methods such as a phosgene process or melt polymerization.

A synthesis method using petroleum-based bisphenol-A as a raw material will be illustrated below. Exemplary phosgene processes include an interfacial polycondensation process using two solvents immiscible with each other, as well as water and dichloromethane; and a process using one solution. In the interfacial polycondensation process, sodium hydroxide is added to an aqueous layer, and, by taking the material bisphenol-A as an example, the bisphenol-A is contained in the aqueous layer. In contrast, diphosgene used as the phosgene is dissolved in dichloromethane. As a result of stirring, a reaction occurs at the interface between the two layers to give a polycarbonate resin, and the polycarbonate resin migrates into the dichloromethane layer. After precipitation, filtration, washing with water, and drying are performed and thereby yields a petroleum-based polycarbonate resin having a bisphenol-A skeleton. In contrast, according to the process using one solution, dichloromethane and other materials are dissolved all together to form a solution, and phosgene gas, for example, is introduced into the solution. Accordingly, polycarbonate resins according to the present invention are very useful typically as coating materials and spinnable fibers.

On the other hand, according to the melt polymerization, for example, bisphenol-A and a carbonic diester are mixed in the presence of a polymerization catalyst to form alcohols and/or phenols through transesterification reaction, and the resulting alcohols and phenols are distilled out at high temperatures under reduced pressure and thereby yield a polycarbonate resin. For easiness in production, the phosgene processes currently occupy about 90% of production processes of polycarbonate resins

For the purpose of being used as various molding materials, the plant-based polycarbonate resins according to the present invention may further include suitable additives such as organic or inorganic fillers, flame retardants, antiblocking agents, crystallization promoters, gas absorbents, age inhibitors, antioxidants, antiozonants, ultraviolet absorbers, photostabilizers, tackifiers, softeners, lubricants, mold-releasing agents, antistatic agents, modifiers, colorants, coupling agents, antiseptic agents, and fungicides.

Plant-based polycarbonate resins according to the present invention may be used as molding materials according to a method not limited, such a conventional kneading method. The kneading may be performed typically with a kneading machine such as a roll, a kneader, a Banbury mixer, an intermix, a single-screw extruder, or a twin-screw extruder. Each of these kneading machines may be used alone or in combination in the kneading.

Molded articles obtained from the molding materials may be produced according to conventional forming methods such as hot-press forming, compression molding, hollow molding, extrusion molding, and injection molding.

The plant-based material for use as a raw material of the polycarbonate resin according to the embodiment (1) or (2) of the present invention is at least one selected from the group consisting of lignin, lignophenol, tannin, xylitol, xylose, sorbitol, and cellulose. Among them, those having aromatic groups, such as lignin, lignophenol, and tannin, are more preferred. This is because the resulting polycarbonate resins have higher glass transition temperatures (hereinafter simply referred to as Tg) which are indices of thermal stability. However, polycarbonate resins using aliphatic plant-based materials fall also within the scope of the present invention, because they have many advantages such as satisfactory formability.

In the polycarbonate resin according to the embodiment (3) of the present invention, the plant-based material serving as a raw material preferably has a weight-average molecular weight of from 300 to 8000 (in terms of polystyrene equivalent conversion). The plant-based material, if having a weight-average molecular weight of less than 300, may often cause the synthesized polycarbonate resin to have a remarkably insufficient strength. In contrast, the plant-based material, if having a weight-average molecular weight of more than 8000, may have insufficient solubility in solvents and may not be suitable as a raw material for the synthesis of polycarbonate resins.

As in the embodiment (4) according to the present invention, the synthesized polycarbonate resin preferably has a weight-average molecular weight of from 2000 to 60000. The plant-based polycarbonate resin, if having a weight-average molecular weight of less than 2000, may often give a molded article having insufficient strength. In contrast, the plant-based polycarbonate resin, if having a weight-average molecular weight of more than 60000, may show insufficient formability.

The polycarbonate resin according to the embodiment (5) of the present invention is a copolymer between the plant-based polycarbonate resin and a polycarbonate resin obtained from a petroleum-based material as a raw material. This copolymer may be prepared by blending arbitrary amounts of a plant-based material having a multiplicity of functional groups and a bifunctional petroleum-based material in an organic solvent, and obtaining, typically through a phosgene process, a polycarbonate copolymer derived from the multifunctional plant-based material and the bifunctional petroleum-based material.

The polycarbonate resin blend according to the embodiment (6) of the present invention is a kneading of the plant-based polycarbonate resin with a petroleum-based polycarbonate resin

Most of petroleum-based polycarbonate resins derived from petroleum-based materials employ bisphenol-A and derivatives thereof as raw materials. The structures of these materials are similar to those of lignin and lignophenol as plant-based materials. For this reason, a petroleum-based polycarbonate resin and a plant-based polycarbonate resin are easily kneadable with each other typically using a single-screw extruder or twin-screw extruder. The petroleum-based polycarbonate resin and the plant-based polycarbonate resin are also kneadable in an arbitrary compositional ratio because of similar structures of these polycarbonate resins.

In the embodiment (7) according to the present invention, the polycarbonate resin preferably has a melt flow rate of 35 g or more and a flexural strength of 60 MPa or more. The polycarbonate resin, when having a melt flow rate of 35 g or more and a flexural strength of 60 MPa or more, is adaptable typically to cabinets of various products. The polycarbonate resin, if having a melt flow rate of less than 35 g, may possibly cause the molded article to have a molding sink or a non-filled portion. In contrast, the polycarbonate resin, if having a flexural strength of less than 60 MPa, may cause a molded cabinet to have an insufficient strength.

The product according to the embodiment (8) of the present invention is a product of every kind which uses a molded article produced from the polycarbonate resin according to (1). Examples of such products include cabinets for various electric appliances such as personal computers, television sets, refrigerators, cleaners, washers, and smoothing irons; automobile parts; materials for clothes; coating materials (paints); and films.

The plant-based polycarbonate resin according to the embodiment (9) of the present invention is a polycarbonate resin derived from a plant-based material, which resin further has at least one type of substituent introduced into part or all of hydroxyl groups of the polycarbonate resin. The embodiment (10) or (11) of the present invention is a method for producing a polycarbonate resin.

A plant-based polycarbonate resin has residual hydroxyl group (s), and this may probably causes the polycarbonate resin to have a higher water absorption. To avoid this, a polycarbonate resin having a less amount of hydroxyl groups may be obtained by dissolving the plant-based polycarbonate resin in a non-alcohol solvent and adding thereto, for example, an acyl chloride compound. Thus, a polycarbonate resin having a low water absorption is obtained.

The present invention will be illustrated in further detail with reference to several working examples below.

The working examples below illustrate synthesis examples, and examples of properties of the resulting synthesized resins. The results of the examples and comparative examples are collectively shown in Table 1 below.

### EXAMPLE 1

In a four-necked flask equipped with mixing impellers, a thermometer, a gas inlet tube, and an exhaust tube were placed 10 ml of pyridine, 100 ml of dry dichloromethane, and 20 g (0.025 mol, hydroxyl group equivalent: 120 g/eq) of lignin, followed by stirring and dissolving. Into the resulting reaction mixture, phosgene gas was introduced at a flow rate of 100 ml/min The reaction mixture was held at 5° C. to 10° C. with ice-cooling. One hour into the gas introduction, the reaction was stopped, the reaction mixture was placed into 1 liter of methanol to precipitate a resin as precipitates. The precipitates were collected by filtration, and the collected precipitates were washed with a 1:1 (by weight) mixture of water and methanol two or three times. This was placed into 250 ml of tetrahydrofuran solvent and dissolved therein with stirring. The resulting solution was placed into 1 liter of methanol to precipitate a resin as precipitates, the precipitates were collected by filtration, and the collected precipitates were washed with a 1:1 (by weight) mixture of water and methanol, and thereby yielded a lignin-based polycarbonate resin.

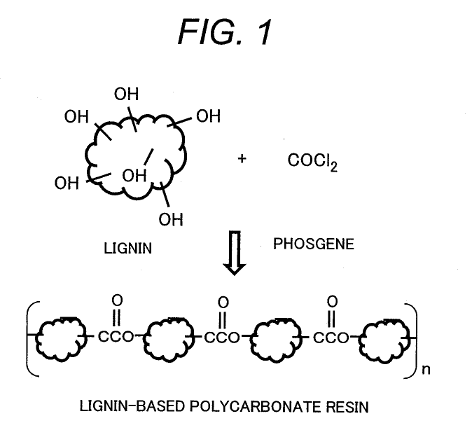

The reaction mechanism between lignin and phosgene is simply illustrated in FIG. 1. Hydroxyl groups of lignin react with phosgene to form carbonic ester bonds, and these bonds link lignin molecules to each other to form a polymer.

Infrared spectrophotometry (IR) of the resulting polycarbonate resin revealed that there were observed absorptions at 1770 cm⁻¹ (C═O stretching vibration of carbonic ester), 1600 cm⁻¹, 1540 cm⁻¹ (C═C stretching vibration of aromatic ring), and 1230 cm⁻¹ to 1160 cm⁻¹ (C—O stretching vibration of aromatic ester). Independently, proton nuclear magnetic resonance spectroscopy (¹H-NMR) of the resin revealed that the lignin-based polycarbonate resin had a peak at 7 to 8 ppm assigned to aromatic ring, a peak at around 3.5 to 4 ppm assigned to methoxy group, and a peak in the range of from 0.5 to 3 ppm assigned to alkyl group. In contrast, a polycarbonate resin obtained from conventional petroleum-based bisphenol-A showed only a peak at 7.3 ppm assigned to aromatic ring, and a peak at 1.7 ppm assigned to methyl group of 2,2-bis(4-hydrooxyphenyl)propane.

The product synthesized in Example 1 was identified as a lignin-based polycarbonate resin based on the results in IR and ¹H-NMR. The properties, such as weight-average molecular weight, solubility, and Tg, of the resin are shown in Table 1. The prepared lignin-based polycarbonate resin was combined with an antioxidant (Irganox 1076, Ciba Japan (now part of BASF Japan Ltd.)) in an amount of 0.1 percent by weight, and melted and kneaded in a single-screw extruder and thereby yielded pellets of the lignin-based polycarbonate resin. Using the pellets, a specimen for melt flow rate measurement was prepared; and a bending specimen was prepared according to the method described in Japanese Industrial Standards (JIS) K-7171 using an injection molding machine (NEX 110, Nissei Plastic Industrial Co., Ltd.) and a die. A three-point bending test was performed on the prepared bending specimen according to the technique described in JIS K-7171 to determine a bending strength (MPa). The test was performed at a bending rate of 1 mm per minute.

Molding Conditions
Temperature: feeding unit: 180° C. to 240° C., kneading unit: 220° C. to 260° C., nozzle: 220° C. to 260° C., die: 60° C. to 110° C.,
Number of revolutions: 30 to 50 rpm
Injection pressure: 9.8 MPa

Melt Flow Rate

A melt flow rate (hereinafter briefly referred to as MFR) is an index of fluidity of a resin and in correlation with the molecular weight. In general, with an increasing MFR, the resin has a decreasing molecular weight, indicating that the resin is more satisfactory in fluidity, i.e., more satisfactory in formability. The measurement of the MFR was performed according to the technique described in JIS K-7210. Specifically, the pellets of the above-prepared plant-based polycarbonate resin were charged into a cylinder of a MFR measurement system, and were compressed using a charging rod. While maintaining the pellets at 260° C., a load of 2.16 kg was applied after a lapse of 4.5 minutes from the charging, and the resin was extruded for 30 seconds. The weight of the resin extruded by this process was converted into a weight of the resin extruded for 10 minutes, and this was defined as a MFR (g/10 minutes).

Weight-Average Molecular Weight

The weight-average molecular weight was determined using an apparatus mentioned below. The weight-average molecular weight was indicated in terms of polystyrene equivalent conversion.
Apparatus: HLC-8200-GPC (Tosoh Corporation)
Detector: 3300RI
Columns: Super AWM-H and Super AW-H
Eluent: 1-methylpyrrolidone
Measurement temperature: 35° C.

Infrared Spectrometry (IR)

The infrared spectrometry was performed using an apparatus FTS3000MX (Bio-Rad Japan Co., Ltd.) according to the KBr tablet method.

¹H-NMR

The ¹H-NMR was performed with an apparatus ECA-500 (JEOL Ltd.) by preparing a solution of the sample in deuterated dimethyl sulfoxide.

Solubility

To 1.0 g of the synthesized resin was added 5.0 g of tetrahydrofuran, followed by stirring for 24 hours using a magnet bar and a stirrer, and how the resin was dissolved was visually observed and assessed. The criteria are as follows:
Good: Completely dissolved
Fair: Undissolved portion partially observed
Poor: Sparingly dissolved

Glass Transition Temperature (Tg)

The bending specimen was cut to give a specimen 4 mm wide, 25 mm long, and about 100 μm thick, and using this specimen, the glass transition temperature (hereinafter briefly referred to as Tg) of the resin was determined with a dynamic viscoelastic analyzer DVA-200 (IT Keisoku Seigyo K. K.) at a rate of temperature rise of 5° C. per minute according to a tensile mode. Specifically, the storage elastic modulus (E′) and loss elastic modulus (E″) were measured, the ratio between them (tan δ=E″/E′) was determined, and the peak temperature of tan δ was defined as Tg.

### EXAMPLE 2

Synthetic preparation was performed according to the process described in Example 1, except for using 70.0 g (0.025 mol) of lignin and 200 ml of dry dichloromethane, and properties of the product were determined. The results are also shown in Table 1.

### EXAMPLE 3

Synthetic preparation was performed according to the process described in Example 1, except for using 72.5 g (0.025 mol) of lignophenol and 200 ml of dry dichloromethane, and properties of the product were determined. The results are also shown in Table 1.

### EXAMPLE 4

Synthetic preparation was performed according to the process described in Example 1, except for using 172.5 g (0.025 mol) of lignophenol and 300 ml of dry dichloromethane, and properties of the product were determined. The results are also shown in Table 1.

### EXAMPLE 5

Example 5 illustrates a working example using hydrolyzable tannin as a plant-based material other than the above materials. Specifically, synthetic preparation was performed according to the process described in Example 1, except for using 55.0 g (0.046 mol) of hydrolyzable tannin and 300 ml of dry dichloromethane, and properties of the product were determined. The results are also shown in Table 1.

### EXAMPLE 6

A polycarbonate resin copolymer was synthetically prepared by the procedure of Example 1, except for mixing and dissolving 160.0 g (0.2 mol) of lignin used in Example 1 and 11.4 g (0.05 mol) of 2,2-bis(4-hydrooxyphenyl)propane, i.e., bisphenol-A as a petroleum-based material, in 400 ml of dry dichloromethane Properties of the copolymer were determined, and the results are also shown in Table 1.

### EXAMPLE 7

A polycarbonate resin copolymer was synthetically prepared by the procedure of Example 1, except for mixing 40.0 g (0.05 mol) of lignin used in Example 1 with 46.0 g (0.2 mol) of 2,2-bis(4-hydrooxyphenyl)propane, i.e., bisphenol-A as a conventional petroleum-based material, and dissolving them in 300 ml of dry dichloromethane. Properties of the copolymer were determined, and the results are also shown in Table 1.

### EXAMPLE 8

A blend was prepared in accordance with the procedure of Example 1 by blending 80 g of the plant-based polycarbonate resin obtained in Example 1 with 20 g of a commercially available polycarbonate resin (regular grade, MW: 32000). Properties of the blend were determined, and the results are also shown in Table 1.

### EXAMPLE 9

A blend was prepared in accordance with the procedure of Example 1 by blending 20 g of the plant-based polycarbonate resin obtained in Example 1 with 80 g of a commercially available polycarbonate resin (regular grade, MW: 32000, MFR: 26 g/10 minutes at 300° C.). Properties of the blend were determined, and the results are also shown in Table 1.

### EXAMPLE 10

In a four-necked flask were placed 384 g (0.48 mol, MW: 800, 120 g/eq) of lignin and 128.5 g (0.6 mol) of diphenyl carbonate, and the mixture was further combined with disodium 4,4′-isopropylidenediphenolate (0.012 g) and tetramethylammonium hydroxide (0.017 g) as polymerization catalysts, followed by dissolving and mixing at 180° C. in a nitrogen atmosphere. While mixing, the reactor (flask) was evacuated to 100 mmHg and held for about 30 minutes while distilling off phenols.

The reaction mixture was then raised in temperature to 200° C., reduced in pressure to 30 mmHg, and held for 20 minutes. The reaction mixture was reacted at a temperature of 260° C. and a pressure of 0.6 mmHg for 2 hours. After being cooled, the reaction mixture was dissolved in 1.5 liters of tetrahydrofuran solvent, and the solution was placed into 3 liters of methanol to precipitate a synthesized resin. The precipitated resin was collected by filtration, washed with a 1:1 (by weight) mixture of water and methanol, further collected by filtration, dried, and thereby yielded a lignin-based polycarbonate resin according to melt polymerization. This was identified as a lignin-based polycarbonate resin through IR and ¹H-NMR as in Example 1. The properties of the prepared resin are also shown in Table 1.

### EXAMPLE 11

An aliquot (200 g (0.25 mol)) of the lignin-based polycarbonate resin obtained in Example 1 was added to and dissolved in 1 liter of dry diethyl ether with stirring. The solution was combined with 15 g (0.65 mol) of metallic sodium, followed by stirring for 24 hours with cooling. After dissolution, unreacted metallic sodium was removed from the reaction mixture. To the reaction mixture with cooling to room temperature or below, 126.5 g (1.0 mol) of benzyl chloride and 79.1 g (1.0 mol) of pyridine were gradually added dropwise. After the completion of dropwise addition, the reaction mixture was stirred at room temperature for 48 hours, and was combined with 500 ml of 5% hydrochloric acid with stirring to precipitate a benzyl-etherified lignin-based polycarbonate resin as precipitates. The precipitates were collected by filtration, and the collected precipitates were washed sequentially with deionized water at 60° C. and with methanol repeatedly, and, after identifying increase in ether bonds (1270 cm⁻¹, 1211 cm⁻¹) adjacent to aromatic ring through infrared spectrophotometry (IR), a benzyl-etherified lignin-based polycarbonate resin was obtained in a yield of 78%. The properties of the resin are also shown in Table 1.

### EXAMPLE 12

Synthetic preparation was performed by the procedure of Example 1, except for using 10 g of a castor oil-based polyol (trade name: URIC H-30 (Itoh Oil Chemicals Co., Ltd.)), 30 g (0.375 mol) of lignin used in Example 1, and 200 ml of dry dichloromethane, and for introducing phosgene for 45 minutes. Properties of the product were determined, and the results are also shown in Table 1. The product had a low Tg of 65° C., because the product is a copolymerized polycarbonate resin using lignin and a non-aromatic plant-based material as raw materials.

### COMPARATIVE EXAMPLE 1

A polycarbonate resin was synthetically prepared under the same conditions as in Example 1, except for using 1,3,5-trihydroxybenzene which is a petroleum-based material and has three hydroxyl groups per molecule. Whether this polycarbonate resin has both satisfactory formability and strength as with the plant-based material polycarbonate resins was investigated. Specifically, 3.15 g (0.025 mol) of 1,3,5-trihydroxybenzene was combined with and dissolved in 20 g of dried dichloromethane and 5 g of pyridine. Thereafter the polycarbonate resin was synthetically prepared according to the procedure of Example 1. The results are shown in Table 1, demonstrating that the polycarbonate resin prepared in Comparative Example 1 was not dissolved in the solvent at all, and the other properties were immeasurable. This is probably because the polycarbonate was crosslinked due to reactions of hydroxyl groups.

### COMPARATIVE EXAMPLE 2

A polycarbonate resin was synthetically prepared according to the procedure of Example 1, except for using 2,2′,4,4′-tetrahydroxybenzophenone which is a petroleum-based material and has four hydroxyl groups per molecule. The resulting polycarbonate resin, however, was not dissolved in the solvent at all, as in Comparative Example 1, and the other properties were immeasurable. This is probably because hydroxyl groups of 2,2′,4,4′-tetrahydroxybenzophenone little suffers from steric hindrance, and a multiplicity of hydroxyl groups are reacted and converted into carbonic esters.

TABLE 1

| | Material | | | Polycarbonate resin | | | | | |
|---|---|---|---|---|---|---|---|---|---|
| | | | Molecular | | | | Molecular | | |
| | | Composition | weight of | Yield | MFR | Flexural | weight of | | Tg |
| | Name | al ratio | material | (%) | (g/10 min.) | strength | resin | Solubility | (° C.) |
| Example 1 | Lignin | 100 | 800 | 85 | 71 | 84 | 8200 | Good | 155 |
| Example 2 | Lignin | 100 | 2800 | 75 | 68 | 86 | 5600 | Good | 182 |
| Example 3 | Lignophenol | 100 | 2900 | 70 | 77 | 90 | 25000 | Good | 165 |
| Example 4 | Lignophenol | 100 | 6900 | 88 | 76 | 105 | 59000 | Good | 185 |
| Example 5 | Tannin | 100 | 1200 | 62 | 50 | 70 | 48000 | Good | 160 |
| Example 6 | Lignin/Bisphenol-A | 80/20 | 800/228 | 72 | 65 | 85 | 15200 | Good | 156 |
| | (copolymer) | | | | | | | | |
| Example 7 | Lignin/Bisphenol-A | 20/80 | 800/228 | 66 | 77 | 88 | 26000 | Good | 146 |
| | (copolymer) | | | | | | | | |
| Example 8 | Resin of Example 1/ | 80/20 | 8200/28000 | — | 99 | 72 | 12600 | Good | 150 |
| | commercially available | | | | | | | | |
| | resin (blend) | | | | | | | | |
| Example 9 | Resin of Example 1/ | 20/80 | 8200/28000 | — | 89 | 70 | 22000 | Good | 145 |
| | commercially available | | | | | | | | |
| | resin (blend) | | | | | | | | |
| Example 10 | Lignin | 100 | 800 | 55 | 48 | 63 | 19000 | Good | 165 |
| Example 11 | Lignin | 100 | 800 | 52 | 48 | 60 | 15200 | Good | 160 |
| Example 12 | Caster oil | 100 | 3600 | 38 | 58 | 60 | 36800 | Good | 24 |
| Com. Ex. 1 | 1,3,5-Trihydroxybenzene | 100 | 126 | 75 | 0 | Specimen | Immeasurable | Poor | unknown |
| | | | | | | unperparable | | | |
| Com. Ex. 2 | 2,2′,4,4′-Tetrahydroxy- | 100 | 246 | 62 | 0 | Specimen | Immeasurable | Poor | unknown |
| | benzophenone | | | | | unperparable | | | |

Table 1 demonstrates that the polycarbonate resins obtained according to Examples 1 to 5 and 9 to 11 using lignin and derivatives thereof as materials have good solubility, relatively high thermal stability (Tg), and high flexural strengths. The copolymers (Examples 6 and 7) and blend (Example 8) of the thus-prepared polycarbonate resin with another resin are also resins having good thermal stability and satisfactory mechanical strength. In addition, the polycarbonate resin synthetically prepared using a vegetable oil, though having somewhat low thermal stability, has relatively high flexural strength and good solvent solubility, and is thereby usable typically as various molding materials and sheet materials.

The above results demonstrate that plant-based materials, though having a multiplicity of hydroxyl groups per molecule, can give, through syntheses, resins having both good formability and satisfactory strength, as compared to resins obtained from petroleum-based materials. In contrast, the polycarbonate resins using petroleum-based materials each having a plurality of hydroxyl groups per molecule were found to be insoluble and infusible. This is probably because hydroxyl groups of the petroleum-based materials are free typically from steric hindrance and are susceptible to reactions, in contrast to the plant-based materials.

What is claimed is:

1. A polycarbonate resin comprising a polymer derived from a plant-based material having a plurality of hydroxyl groups, molecules of the plant-based material being linked to each other through carbonate groups to form the polymer.

2. The polycarbonate resin according to claim 1, wherein the plant-based material is at least one selected from the group consisting of lignin, lignophenol, and tannin.

3. The polycarbonate resin according to claim 1, wherein the plant-based material is at least one selected from the group consisting of xylitol, xylose, sorbitol, cellulose, and vegetable oils.

4. The polycarbonate resin according to claim 1, wherein the plant-based material has a weight-average molecular weight of from 300 to 8000.

5. The polycarbonate resin according to claim 1, wherein the polycarbonate resin has a weight-average molecular weight of from 2000 to 60000.

6. A polycarbonate resin comprising a copolymer of a plant-based material having a plurality hydroxyl groups and a bifunctional hydroxyl-containing petroleum-based material, hydroxyl groups of the plant-based material and hydroxyl groups of the petroleum-based material being converted into carbonate groups and linked to each other to form the copolymer.

7. A polycarbonate resin blend as a kneading of the plant-based polycarbonate resin of claim 1 with a petroleum-based polycarbonate resin.

8. The polycarbonate resin according to claim 1, wherein the polycarbonate resin has a melt flow rate of 35 g or more and a flexural strength of 60 MPa or more.

9. A product comprising a molded article of the polycarbonate resin of claim 1.

10. A method for producing a polycarbonate resin, comprising the steps of:
converting part or all of hydroxyl groups of a plant-based material having a plurality of hydroxyl groups into carbonate groups; and
polymerizing the plant-based material.

11. A method for producing a polycarbonate resin, comprising the steps of:
linking a plant-based material having a plurality of hydroxyl groups and having a weight-average molecular weight of 8000 or less and a bifunctional petroleum-based material to each other through carbonate groups; and
copolymerizing the two materials.

12. A method for producing a polycarbonate resin, comprising the steps of:
converting part or all of hydroxyl groups of a plant-based material having a plurality of hydroxyl groups into carbonate groups through melt polymerization; and
polymerizing the plant-based material.
